(19) United States
(12) Patent Application Publication
(10) Pub. No.: US 2023/0160205 A1
(43) Pub. Date: May 25, 2023

(54) Layered Panels

(71) Applicant: Merged Materials, Hudsonville, MI (US)

(72) Inventor: Randolph Woellper, Hudsonville, MI (US)

(21) Appl. No.: 17/809,725

(22) Filed: Jun. 29, 2022

Related U.S. Application Data
(60) Provisional application No. 63/282,029, filed on Nov. 22, 2021.

(51) Int. Cl. E04C 2/26; B32B 3/08; B32B 5/18; B32B 21/04; B32B 27/06; B32B 3/28; B32B 3/12; E04C 2/34

(52) U.S. Cl. CPC E04C 2/26; B32B 3/085; B32B 5/18; B32B 21/047; B32B 27/065; B32B 3/28; B32B 3/12; E04C 2/34; B32B 2307/54; B32B 2419/00; E04C 2002/3488

(57) ABSTRACT

The present invention provides layered panel that comprises a filler insert, a dense frame and a bond frame having at least one rectangular dense frame opening, a first external layer having a rectangular shape and a flat surface, and a second external layer.

### FIELD OF THE INVENTION

The present invention relates to panels. More specifically, the present invention is a multi-layered construction panel.

### BACKGROUND OF THE INVENTION

When it comes to construction panels, there are many different panels that are utilized in the construction industry. Depending on the project, different panels may be used to best fit the need of the specified project. Panels are typically constructed of high tensile sheets from many materials such as laminate, veneers, tensioned extrusions, etc. Panels are used ubiquitously in many applications and industries throughout the world. As construction and projects evolve and become more complex throughout history, it is important to innovate and update panels to the best quality in order to successfully and optimally to be used.

An objective of the present invention is to provide a lightweight panel comprising of multiple layers. The present invention provides a panel with the surface layers pinched at the edges to increase the strength and rigidity compared to standard existing panels. The present invention provide a strong, lightweight, aesthetic and antimicrobial efficacy panel.

### SUMMARY

In accordance with the present invention, a novel layered panel that comprises a filler insert, a dense frame and a bond frame having at least one rectangular dense frame opening, a first external layer having a rectangular shape and a flat surface, and a second external layer having a rectangular shape and a flat surface.

In one embodiment, the first external layer includes at least one curved side edge; and the second external layer includes at least one curved side edge.

In another embodiment, the second external layer includes at least one pinched side edge. The one or more layers may be replaced with a single lightweight material such as composite, wood, or of the likes.

### BRIEF DESCRIPTION OF THE DRAWINGS

FIG. 1 is an exploded view of the present invention showing the different layers (a first external layer, dense frame, filler insert, bond frame, and second external layer).

FIG. 2 is an illustration of one embodiment of the first external layer of the present invention.

FIG. 3 is an illustration of one embodiment of the second external layer of the present invention.

FIG. 4 is an illustration of one embodiment of the second external layer of the present invention with a front curved surface and back curved surface.

FIG. 5 is an illustration of one embodiment of the dense frame of the present invention.

FIG. 6 is an illustration of one embodiment of the filler insert of the present invention.

FIG. 7 is an illustration showing one embodiment of the sloped sides of the bond frame of the present invention.

FIG. 8 is an illustration of one embodiment of a bottom surface of the bond frame with upwardly-extending bond frame walls.

FIG. 9 is a cross-sectional view of one embodiment of the present invention with a gap space.

### DETAIL DESCRIPTIONS OF THE INVENTION

All illustrations of the drawings are for the purpose of describing selected versions of the present invention and are not intended to limit the scope of the present invention.

The present invention is to provide a lightweight panel comprising of multiple layers. The present invention provides a panel with the surface layers pinched at the edges to increase the strength and rigidity compared to standard existing panels. The present invention provides a strong, lightweight, aesthetic, and antimicrobial efficacy panel. The present invention comprises a first external surface, a dense frame, a filler insert, a bonding frame, and a second external layer.

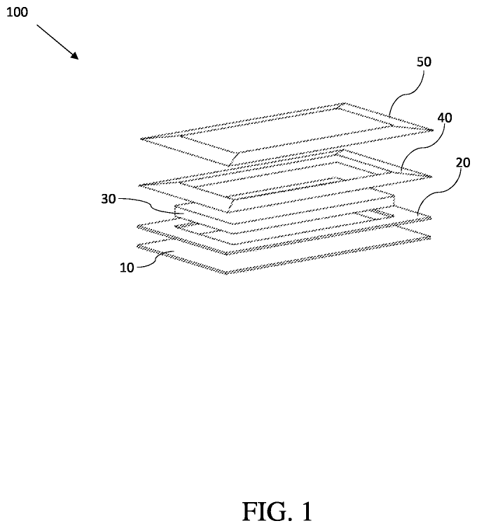

In reference to FIG. 1, the present invention provides a layered panel 100 and is shown in an exploded configuration. The present invention provides a layered panel 100 made of five different layers. The five layers of the layered panel 100 are the first external layer 10, the dense frame 20, the filler insert 30, the bond frame 40, and the second external layer 50. Layers can be placed on top of each other. The edges of the first external layer 10 can be attached to the dense frame 20 and the second external layer 50 can be attached to the bond frame 40 to form a layered panel 100 of the present invention.

The five layers method of construction can provide a higher degree of strength than a typical laminated board of the same materials but without the pinched edges.

The present invention is constructed with one or more frames (e.g., the dense frame 20, the bond frame 40) and an inner lightweight core material (e.g., the filler insert 30). The one or more forementioned elements/components may be replaced with a single lightweight material such as composite, wood, or of the likes.

The first external surface 10 is the first exterior layer with an exposed high strength visual surface.

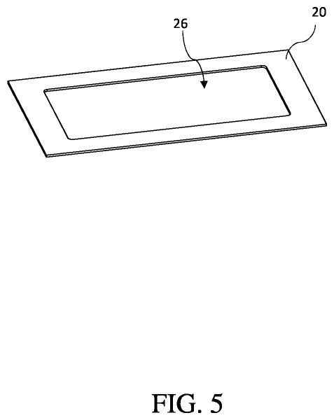

The dense frame 20, shown in FIG. 5, can include a strong dense material with a high flexural modulus which help to maintain the flatness of the panel's surface.

The flexural modulus, determined from the slope of a stress-strain curve produced by a flexural test, is computed as the ratio of stress to strain in flexural deformation, or the tendency for a material to resist bending.

The higher the flexural modulus of a material, the harder it is to bend. A higher flexural modulus material, therefore, is stiffer than a lower flexural modulus material. In some embodiments, the present invention may include a dense frame having a flexural modulus of at least 10 GPa and a flexural strength of at least 90 MPa.

In some embodiments, the dense frame 20 may include at least one rectangular dense frame opening 26.

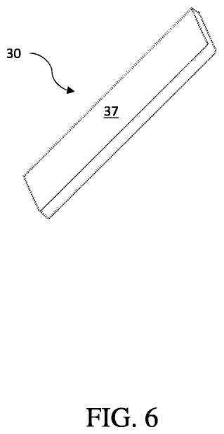

The filler insert 30, as shown in FIG. 6, can include a lightweight material such as foam, honeycomb, etc.

In some embodiments, the filler insert 30 can be a flat plane with an inner rectangular area 37 configured to fit in the dense frame opening 26 and/or the bond frame opening 46.

The bond frame 40 can include any material that typically has bonding properties such as wood, plastic, composite, etc.

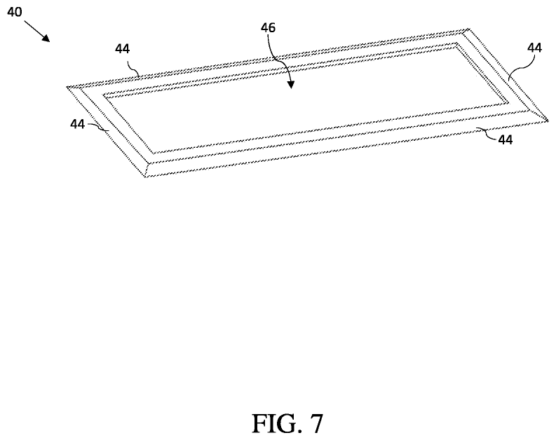

In some embodiments, the bond frame 40, as shown in FIG. 7, may be of a rectangular shape and may include at least one bond frame opening 46. The bond frame 40 may also include sloped sides 44.

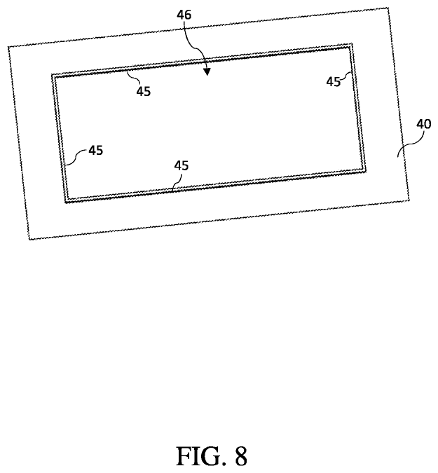

In some embodiments, as shown in FIG. 8, the bond frame 40 may include a plurality of upwardly-extending bond frame walls 45 defining the bond frame opening 46. The height of the upwardly-extending bond frame walls 45 may be the same as the thickness of the bond frame opening 46.

The second external layer 50 is the second exterior layer with an exposed high strength visual surface.

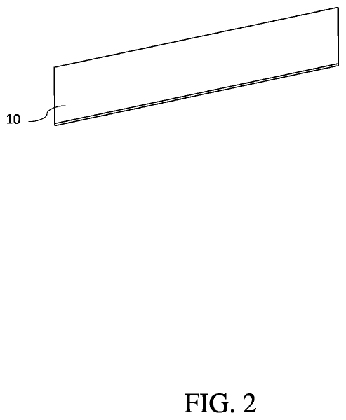

The first external surface 10 is a flat surface as illustrated in FIG. 2. In one embodiment, the first external surface 10 can be of a rectangular shape.

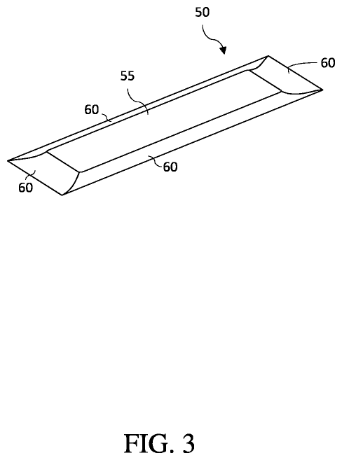

In reference to FIG. 3, the second external layer 50 of the present invention is shown. The second external surface 50 can also be of a rectangular shape and include pinched edges 60 outlining the rectangular shape of the second external layer 50. In some embodiments, second external layer 50 can include a protruded surface 55.

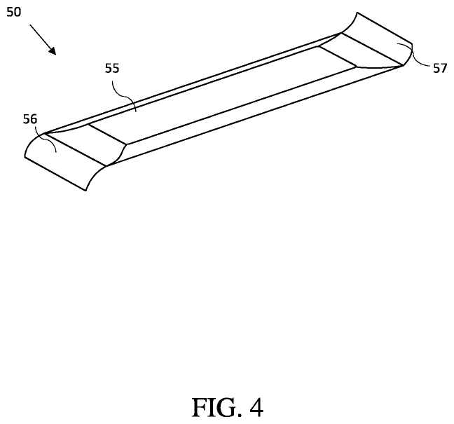

As can be seen in FIG. 4, in some embodiments, the second external layer 50 can include a front curved surface 56 and a back curved surface 57 create a stronger layered panel 100 with the benefit of a “soft” front/back edge.

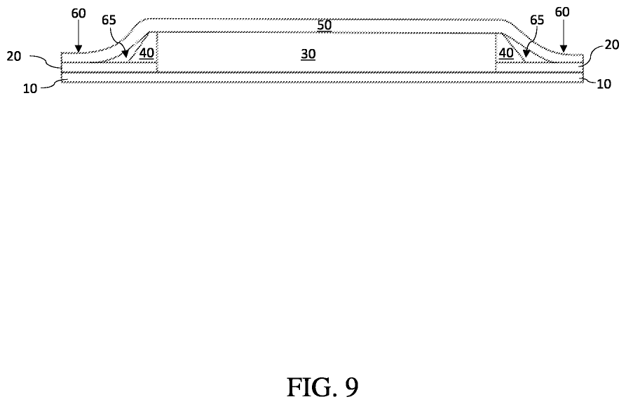

In reference to FIG. 9, in some embodiments, the size of the second external layer 50 can be larger than the bond frame 40. In such embodiments, a layered panel 100 of the present invention can include a gap space 65 between the bond frame 40 and the second external layer 50.

The present invention introduces a panel that is constructed by using a lightweight interior with a high strength surface alongside compressed/pinched edges 60 and/or curved edges (front curved surface 56 and a back curved surface 57). With curving the edges after the pinched area (pinched edges 60), the present invention provides a stronger panel (layered panel 100) with the additional benefit of alternative aesthetics compared to existing panels. Note that the curved edges (the front curved surface 56 and the back curved surface 57) after the pinched area (pinched edges 60) may be positioned optionally on any number of edges of the layered panel 100.

Although the invention has been explained in relation to its preferred embodiment, it is to be understood that many other possible modifications and variations can be made without departing from the spirit and scope of the invention.

1. A layered panel comprising:
a filler insert formed from a first material;
a dense frame having at least one rectangular dense frame opening and a bond frame formed from a second material and having at least one rectangular bond frame opening, wherein the bond frame includes at least one slope side, the dense frame and the bond frame are disposed on opposing surfaces of the filler insert configured to fit in the at least one rectangular dense frame opening and the at least one rectangular bond frame opening;
a first external layer having a rectangular shape and a flat surface, wherein the first external layer is disposed on the dense frame;
a second external layer having at least one pinched edge and a protruded surface, wherein the second external layer is larger than the bond frame, the second external layer is disposed on the bond frame so that there is a gap space between the bond frame and the second external layer;
a front curved surface attached to the second external layer; and
a back curved surface attached to the second external layer.

2. The layered panel as claimed in claim 1, wherein the first material is a foam.

3. The layered panel as claimed in claim 1, wherein the second material is wood.

4. The layered panel as claimed in claim 1, wherein the second material is plastic.

5. The layered panel as claimed in claim 1, wherein the second material is composite.

6. The layered panel as claimed in claim 1, wherein the dense frame has a flexural modulus of at least 10 GPa and a flexural strength of at least 90 MPa and the bond frame is formed from a second material.

7. A layered panel comprising:
a filler insert formed from a first material;
a dense frame having at least one rectangular dense frame opening and a bond frame having at least one rectangular bond frame opening, wherein the dense frame and the bond frame are disposed on opposing surfaces of the filler insert, the bond frame formed from a second material;
a first external layer having a rectangular shape and a flat surface, wherein the first external layer is disposed on the dense frame; and
a second external layer having a rectangular shape and a protruded surface, wherein the second external layer is disposed on the bond frame.

8. The layered panel as claimed in claim 7, wherein the first material is a foam

9. The layered panel as claimed in claim 7, wherein the first material is a honeycomb.

10. The layered panel as claimed in claim 7, wherein the second material is wood.

11. The layered panel as claimed in claim 7, wherein the second material is plastic.

12. The layered panel as claimed in claim 7, wherein the second material is composite.

13. The layered panel as claimed in claim 7, wherein the dense frame has a flexural modulus of at least 10 GPa and a flexural strength of at least 90 MPa and the bond frame is formed from a second material.

14. A layered panel comprising:
A filler insert formed from a first material;
a dense frame having at least one rectangular dense frame opening and a bond frame having at least one rectangular bond frame opening, wherein the dense frame and the bond frame are disposed on opposing surfaces of the filler insert, the bond frame formed from a second material and includes a plurality of upwardly-extending bond frame walls;
a first external layer having a rectangular shape and a flat surface, wherein the first external layer is disposed on the dense frame; and
a second external layer having a rectangular shape and a protruded surface, wherein the second external layer is disposed on the bond frame, the second external layer includes at least one pinched edge.

15. The layered panel as claimed in claim 14, wherein the first material is a foam.

16. The layered panel as claimed in claim 14, wherein the first material is a honeycomb.

17. The layered panel as claimed in claim 14, wherein the second material is wood.

18. The layered panel as claimed in claim 14, wherein the second material is plastic.

19. The layered panel as claimed in claim 14, wherein the second material is composite.

20. The layered panel as claimed in claim 14, wherein the dense frame has a flexural modulus of at least 10 GPa and a flexural strength of at least 90 MPa and the bond frame is formed from a second material.
